(19) United States
(12) Patent Application Publication
(10) Pub. No.: US 2012/0260015 A1
(43) Pub. Date: Oct. 11, 2012

(54) PCI EXPRESS PORT BIFURCATION SYSTEMS AND METHODS

(76) Inventors: Raphael Gay, Fort Collins, CO (US); Robert J. Horning, Fort Collins, CO (US); Robert Bohl, Fort Collins, CO (US); Brooke Melinda O'Dell Loader, Fort Collins, CO (US)

(21) Appl. No.: 13/082,282

(22) Filed: Apr. 7, 2011

(51) Int. Cl. G06F 13/14

(52) U.S. Cl. 710/301

(57) ABSTRACT

Peripheral Component Interconnect Express (“PCIe”) Port bifurcation systems and methods are provided. An illustrative PCIe port bifurcation card can include: a PCIe interface and a plurality of PCIe devices, each independently coupled to the interface via an unswitched connection. The card can further include a read only memory (ROM) coupled to the interface, the ROM can include bifurcation data. A clocking signal replicator can be coupled to the interface to: replicate a reference clock signal received via the interface and provide the replicated reference dock signal to each of the plurality of PCIe devices.

### BACKGROUND OF THE INVENTION

### Description of the Related Art

The smaller chassis provided with modern electronic devices often serves to limit the number of available expansion slots within the chassis. It therefore becomes important to increase the flexibility and usefulness of each available expansion port within such devices.

### BRIEF DESCRIPTION OF THE DRAWINGS

Advantages of one or more disclosed embodiments may become apparent upon reading the following detailed description and upon reference to the drawings in which:

FIG. 1 is a schematic depicting an illustrative port bifurcation card, according to one or more embodiments described herein;

FIG. 2 is a schematic depicting an illustrative port bifurcation system, according to one or more embodiments described herein;

FIG. 3 is a schematic depicting another illustrative port bifurcation system, according to one or more embodiments described herein;

FIG. 4 is a flow diagram depicting an illustrative port bifurcation tad, according to one or more embodiments described herein; and

FIG. 5 is a flow diagram depicting another illustrative port bifurcation method, according to one or more embodiments described herein.

### DETAILED DESCRIPTION

The decrease in size of modern electrical devices limits the number of components, such as expansion slots, mounted on printed circuit boards disposed within the chassis. Recently, the integration of Peripheral Component Interconnect (“PCI”) and PCI Express (“PCIe”) interfaces into computing devices has provided device manufacturers with a single, versatile, yet standard architecture and protocol accommodating a variety of peripheral devices such as storage expanders, video expansion cards, audio expansion cards, network adapters, and the like. Unfortunately, particularly in small chassis electronic devices, the number of PCIe expansion slots may not be sufficient to accommodate all of the user's PCIe expansion devices.

The ability to support multiple PCIe devices using a single PCIe slot or interface can be accomplished using a temporal sharing based system employing a switch or router. The imposition of a switch or router can make it possible for multiple PCIe devices to share all or a portion of a single PCIe interface. For example, a router or switch can be disposed between the PCIe devices and the PCIe interface thereby permitting each of the PCIe devices the ability to temporally share all or a portion of a single PCIe interface. Integration of router or switch based PCIe interface sharing systems can increase the base cost of the system and can consume valuable real estate within the chassis of the electronic device.

In order to accommodate multiple PCIe devices using a single PCIe slot system manufacturers may customize the PCIe architecture, PCIe protocol, or both the PCIe architecture and protocol to support multiple PCIe devices. However, by customizing the architecture or protocol, the ability to add PCIe devices supplied by manufacturers other than the system manufacturer may be reduced or eliminated since each architecture or protocol is non-standard and peculiar to the specific system manufacturer. The ability to increase the flexibility and usefulness of an expansion port while maintaining an industry standard PCIe architecture and protocol can permit the use of PCIe devices sourced from multiple manufacturers since an industry standard, rather than manufacturer specific, architecture and protocol.

As used herein the terms PCIe slot, PCIe connector, and PCIe interface refer to any slot, connector, and interface fully compliant with the Peripheral Component Interconnect—Special Interest Group (“PCI-SIG”) PCI Express™® Card Electromechanical Specification (Revision 1.0 and later). Such PCIe slots, connectors, and interfaces can also be variously and equally referred to herein as representing a “standard” or an “industry standard.” Such “standard” or “industry standard” PCIe slots, connectors, and interfaces do not incorporate any non-conforming PCIe connector pinout.

Peripheral Component Interconnect Express (“PCIe”) port bifurcation cards are provided. An illustrative PCIe port bifurcation card can include: a PCIe interface and a plurality of PCIe devices, each independently coupled to the interface via an unswitched connection. The card can further include a read only memory (ROM) coupled to the interface, the ROM can include bifurcation data. A clocking signal replicator can be coupled to the interface to: replicate a reference clock signal received via the interface and provide the replicated reference dock signal to each of the plurality of PCIe devices.

PCIe port bifurcation methods are also provided. An illustrative PCIe port bifurcation method can include apportioning a PCIe interface into a plurality of independent links, each of the plurality of independent links coupled via an unswitched connection to a PCIe device. The method can further include programming a controller to communicate with each of the plurality of PCIe devices via at least one of the plurality of links.

PCIe port bifurcation systems are also provided. An illustrative PCIe port bifurcation system can include a computing device including at least one PCIe slot, a controller, and a System Management bus (“SMBus”). The system can further include a PCIe card coupled to the PCIe slot. The PCIe card can include a plurality of PCIe devices, each device independently coupled via an unswitched connection to a PCIe interface bifurcated into a plurality of independent links; a read only memory (ROM) to communicate bifurcation data from the ROM to the controller via the SMBus upon powering of the PCIe card; and a phase lock loop coupled to the interface to replicate a reference clock signal and to provide the replicated reference clock signal to each of the plurality of PCIe devices.

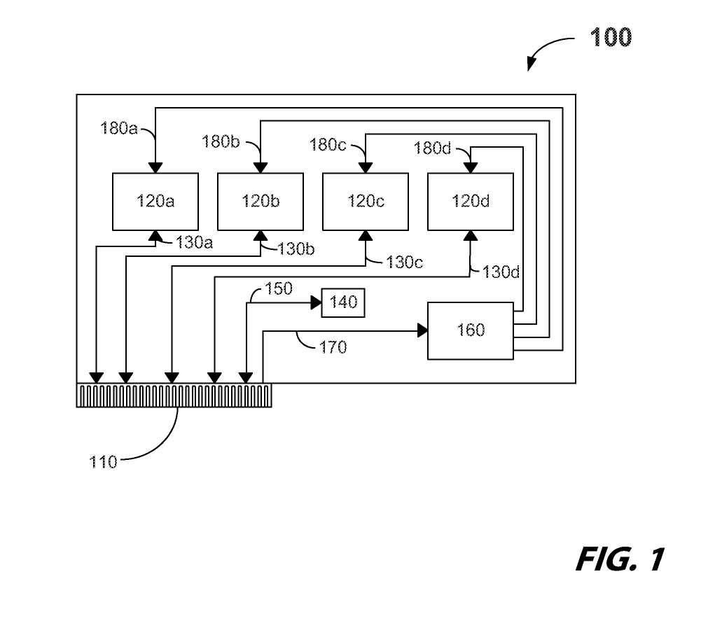

FIG. 1 is a schematic depicting an illustrative port bifurcation card 100, according to one or more embodiments. The PCIe port bifurcation card 100 can include one or more devices, systems, or combination of systems and devices permitting the contemporaneous operation of a plurality of PCIe devices 120a-d via a single PCIe interface 110. The card 100 can be coupled to an external system via the PCIe interface 110 thereby supporting the contemporaneous, unswitched operation of at least a portion of the plurality of PCIe devices 120a-d. Each of the plurality of PCIe devices 120a-d can be independently coupled 130a-d to the PCIe interface 110. In operation, at least a portion of the plurality of PCIe devices 120a-d can be contemporaneously supported by apportioning or bifurcating the PCIe interface 110 into a plurality of links, with each of the plurality of PCIe devices 120a-d capable of contemporaneously communicating with an external device, such as a controller, via at least one of the plurality of links.

A storage device, such as a read only memory (“ROM”) 140 can be disposed on the card 100. At least a portion of the ROM 140 can include non-volatile data storage. At least a portion of the non-volatile data stored within the ROM 140 can include bifurcation data related to the card 100. For example, non-volatile port bifurcation data stored within the ROM 140 may identify the card 100 as a x16 PCIe card having the PCIe interface x16 link bifurcated into four, independent, equal width, x4 PCIe links, each x4 link composed of four full-duplex, bidirectional, lanes.

A docking signal replicator 160 can also be disposed on or about the card 100. The docking signal replicator 160 can replicate a reference clock signal 170 received via the PCIe interface 110. The replicated reference dock signal 180a-d can be supplied to at least a portion of the plurality of PCIe devices 120a-d. The supply of a replicated reference clock signal 180a-d to each of the plurality of PCIe devices 120a-d can permit the synchronous operation of at least a portion of the PCIe devices 120a-d.

The PCIe interface can be apportioned, divided, or otherwise bifurcated to provide a plurality of independent links composed of any number of lanes, for example the PCIe interface can include one or more one lane (x1), four lane (x4), eight lane (x8), twelve lane (x12), or sixteen lane (x16) link(s). The PCIe interface 110 can be coupled to a PCIe slot, for example a PCIe slot coupled to a PCIe interface disposed within an electronic device. The PCIe interface 110 can support contemporaneous, full duplex communication between each of the plurality of PCIe devices 120a-d and a remote device, for example a PCIe controller.

The standard PCIe interface can be bifurcated or otherwise apportioned to provide a plurality of independent links, with each of the plurality of PCIe devices 120a-d independently coupled to at least one of the plurality of links. For example using an illustrative x16 PCIe interface 110, the 16 lanes comprising the link can be equally or unequally apportioned to provide an independent link (each link composed of any number of lanes) for each of the plurality of PCIe devices 120a-d. In one embodiment, the 16 lanes can be equally bifurcated to provide four independent, equal width links (16 lanes providing four x4 links, each of the four x4 links composed of 4 lanes), each of the plurality of independent links coupled 130a-d to each of the plurality of PCIe devices 120a-d, in other embodiments, the 16 lanes can be unequally bifurcated to provide a plurality of independent, unequal width links (16 lanes providing, for example two x2 links [2 lane], one x4 link [4 lane], and one x8 link [8 lane]) each of the plurality of independent, unequal width links can be coupled 130a-d to each of the plurality of PCIe devices 120a-d.

The plurality of PCIe devices 120a-d can include any device, system, or combination of systems and devices adapted to communicate with an external device via a PCIe interface. Although four PCIe devices 120a-d are depicted in FIG. 1, any number of PCIe devices can be similarly coupled, connected, and arranged. Representative PCIe devices can include, but are not limited to, external network communication devices, graphics adapters, audio adapters, and storage devices. Each of the plurality of PCIe devices 120a-d can be directly coupled to the PCIe interface 110. A direct coupling of each of the plurality of PCIe devices 120a-d to the PCIe interface 110 can eliminate the need for intervening switches or routers since each of the plurality of PCIe devices 120a-d can access at least a portion of the PCIe interface 110.

In some embodiments, the plurality of PCIe devices 120a-d can each use an equal width link, for example each of the four PCIe devices depicted in FIG. 1 can use a x4 link. In other embodiments, all or a portion of the plurality of PCIe devices 120a-d can use an unequal width link, for example each of the four PCIe devices depicted in FIG. 1 can independently use a x2 link, x4 link, or x8 link. Although the plurality of PCIe devices 120a-d are depicted as being physically coupled to the card 100, in at least some embodiments, all or a portion of the plurality of PCIe devices 120a-d can be remotely coupled to the card 100.

The read only memory (“ROM”) 140 disposed on the card 100 can include any at least partially non-volatile storage device suitable for storing digital data. In at least some embodiments, digital data can be permanently stored within the ROM 140. The ROM 140 can be coupled 150 to the PCIe interface 110. The digital data within the ROM 140 can include data related to the card 100, for example data detailing the bifurcation capability of the card 100 can be permanently stored within the ROM 140. Data related to the bifurcation capability of the card 100 can, in some embodiments, be transmitted to an external device such as a PCIe controller coupled to the card 100. In at least some embodiments, the data stored within the ROM 140 can be communicated to an external device coupled to the card upon the initial application of power to the card 100. The data stored within the ROM 140 can be transmitted to an external device such as a PCIe controller via the PCIe interface 110, for example across a System Management Bus (“SMBus”—pins 5 and 6 of the PCIe interface 110). Transmission of the bifurcation capabilities of the PCIe port bifurcation card 100 can permit the contemporaneous operation of the plurality of PCIe devices 120a-d by a single PCIe controller.

The clocking signal replicator 160 can include any number of device, systems, or any combination of systems and devices suitable for receiving a reference clock signal 170, while providing a plurality of replicated reference clock signals 180a-d. While four illustrative outputs are depicted in FIG. 1, any number of replicated reference clock signals 180 may be generated by the clocking signal replicator 160. At least a portion of the plurality of replicated reference clock signals 180a-d can be communicated to the plurality of PCIe devices 120a-d. In at least some embodiments, a reference clock input 170 can be communicated from the PCIe interface 110 to the clocking signal replicator 160. In some embodiments, the reference clock input 170 can be provided via the SMBus (e.g., pin 5 of the PCIe interface 110).

The clocking signal replicator 160 can include a phase locked loop (“PLL”). The replicator 160 can include additional components to minimize the skew between the plurality of replicated reference clock signals 180a-d and to filter at least a portion of the plurality of replicated reference clock signals 180a-d to minimize signal jitter.

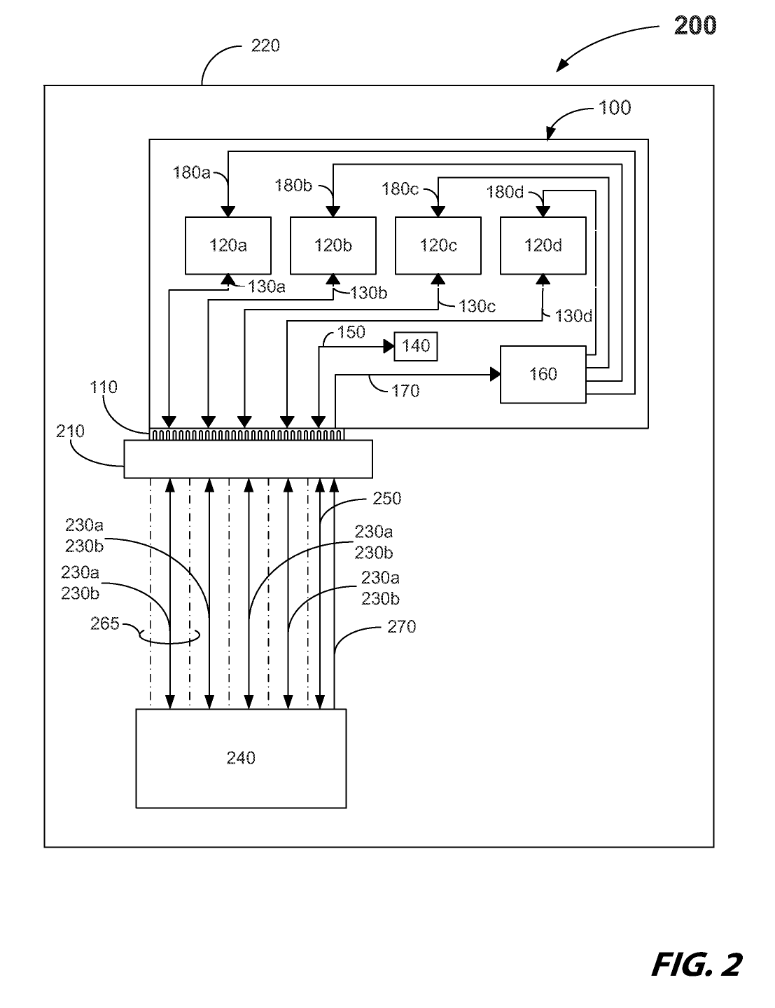

FIG. 2 is a schematic depicting an illustrative port bifurcation system 200, according to one or more embodiments. FIG. 2 depicts the PCIe interface 110 of the PCIe interface card 100 described in detail with reference to FIG. 1 coupled to a complimentary PCIe slot 210. The PCIe slot 210 is coupled to a controller 240. In at least some embodiments, the PCIe card 100 and the controller 240 can be at least partially disposed within an enclosure 220. In at least some embodiments, the enclosure 220 can be a computing device such as a desktop, portable, or blade computer.

The PCIe interface 110 can be apportioned or bifurcated to provide a plurality of links 265, each link composed of at least one bidirectional, full-duplex, lane 230. Each of the plurality of links 265 can be an equal width (i.e., each link 265 composed of an equal number of lanes 230a), or an unequal width (i.e., at least two of the links 265 composed of an unequal number of lanes 230b). The PCIe interface 110 can include an SMBus data link 250. The PCIe interface 110 includes a reference clock signal 270. The PCIe interface 110 and PCIe slot 210 coupled thereto can include any industry standard PCIe interface 110 and PCIe slot, including but not limited to a x2, x4, x8, x12, x16, or x32 lane slot. Each of the plurality of PCIe devices 120a-d can be coupled 130a-d without an intervening device, switch, router, or the like, to the PCIe interface 110.

In some embodiments, the PCIe interface 110 can be bifurcated or otherwise apportioned to provide a plurality of parallel, equal width, links 265. In other embodiments, the PCIe interface 110 can be bifurcated or otherwise apportioned to provide a plurality of parallel, unequal width, links 265. In some embodiments, each of the links 265 can be coupled to at least a portion of the bifurcated PCIe interface 110 via the PCIe slot 210. The PCIe interface 110 can, in turn, be coupled 130a-d to one or more of the plurality of PCIe devices 120a-d.

In other embodiments, the controller 240 can logically and physically apportion the PCIe interface 110 to match the PCIe card 100 bifurcation data communicated from the ROM 140 to the controller 240 via at least a portion of the PCIe interface 110. The ROM 140 can communicate the bifurcation capability of the PCIe card 100 via the SMBus data link 250.

The controller 240 can provide a reference clocking signal 270 to the PCIe slot 210. The controller 240 can include any number of systems, devices, or any combination of systems and devices configured to support a bifurcated PCIe interface 110 while coupling the bifurcated PCIe card 100 with an external device such as a southbridge disposed within a computing device. In at least some embodiments, the reference clocking signal can be provided in whole or in part by a system clocking signal generated by the system 200. In other embodiments, the reference clock signal 170 can be provided in whole or in part by the SMBus clock signal. In other embodiments, the reference clock signal 170 can be provided in whole or in part via the reference clock communicated via the PCIe interface (pins 13 and 14).

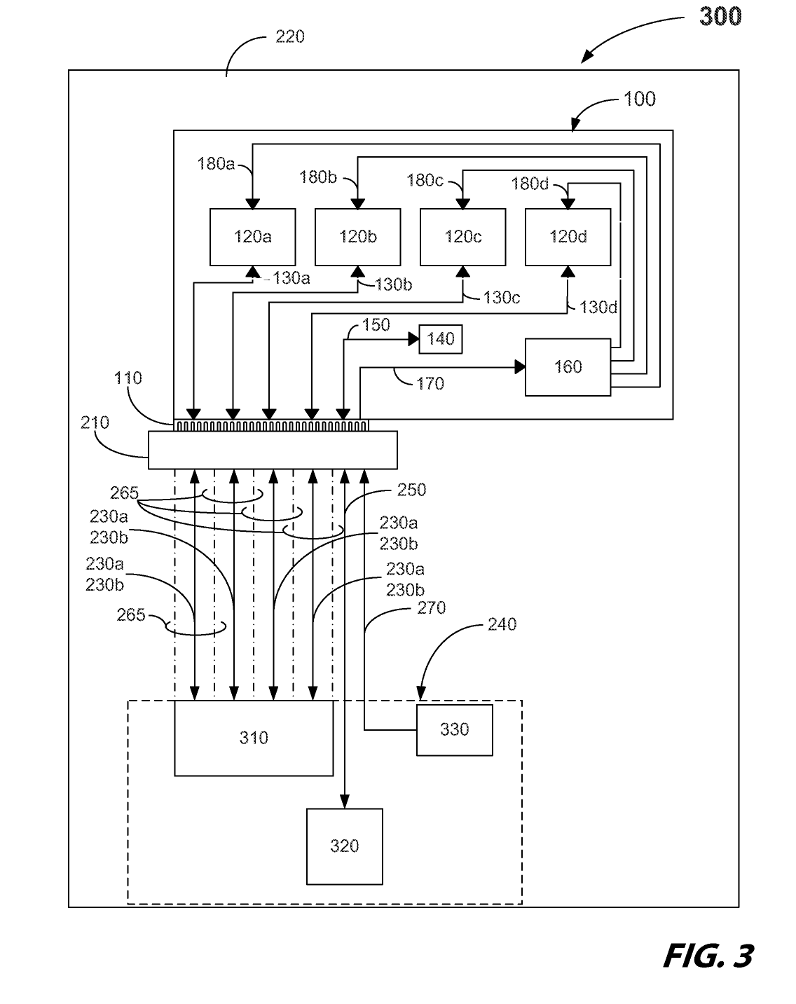

FIG. 3 is a schematic depicting another illustrative port bifurcation system 300, according to one or more embodiments. In at least some embodiments, the controller 240 can include a plurality of discrete controllers, for example a discrete PCIe controller 310; a discrete SMBus controller 320; and a discrete clock controller 330. In at least some embodiments, all or a portion of the PCIe controller 310, SMBus controller 320, and clock controller 330 can be coupled to the PCIe interface 110.

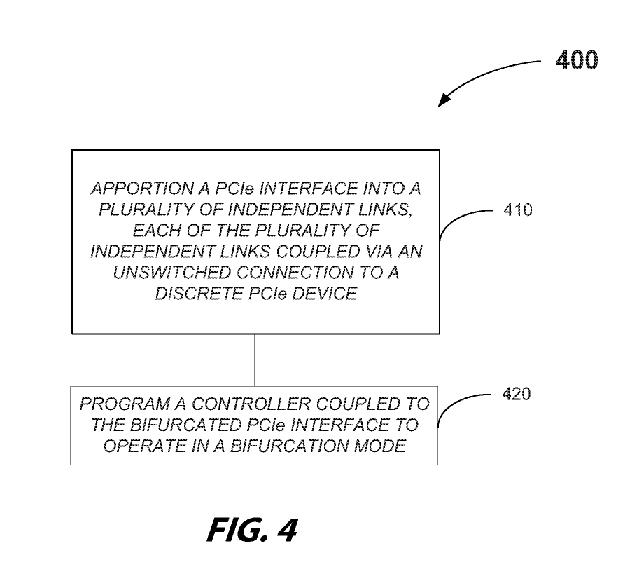

FIG. 4 is a flow diagram depicting an illustrative port bifurcation method 400, according to one or more embodiments. The method can include apportioning a PCIe interface 110 coupled to a PCIe port bifurcation card 100 into a plurality of independent links 265. Each of the plurality of independent links 265 can be coupled to a discrete PCIe device 120a-d via the card 100. The controller 240, for example the PCIe Controller 320, can be programmed to operate in a bifurcated mode.

The method 400 can include at 410, apportioning the PCIe interface 110 into a plurality of independent links 265. Each of the plurality of independent links 265 coupled via an unswitched connection to a discrete PCIe device 120a-d. The apportionment of the PCIe interface 110 into a plurality of independent links 265 can, at least in some embodiments, be based upon the transmission of bifurcation data from the ROM 140 disposed on the PCIe port bifurcation card 100 to the controller 240. The port bifurcation data transmitted to the controller 240 can include the width of (i.e. number of lanes 230a, 230b forming) each of the plurality of links 265. In at least some embodiments, the port bifurcation data can be transmitted via the SMBus 250 from the ROM 140 through the PCIe interface 110 to the controller 240.

In response to the bifurcation of the PCIe interface 110 at 410, the controller 240 can be programmed to operate in a bifurcation mode at 420. Based upon the number of PCIe devices 120 coupled via the PCIe port bifurcation card 100 to the PCIe interface 110, the controller 240 can be programmed to contemporaneously communicate with each of the plurality of PCIe devices 120. Since the coupling of each of the plurality of PCIe devices to the controller 240 is accomplished without the use of an intervening switch or router, the controller 240 is thus provided the ability to simultaneously or contemporaneously communicate with each of the plurality of PCIe devices 120a-d coupled to the PCIe interface 110.

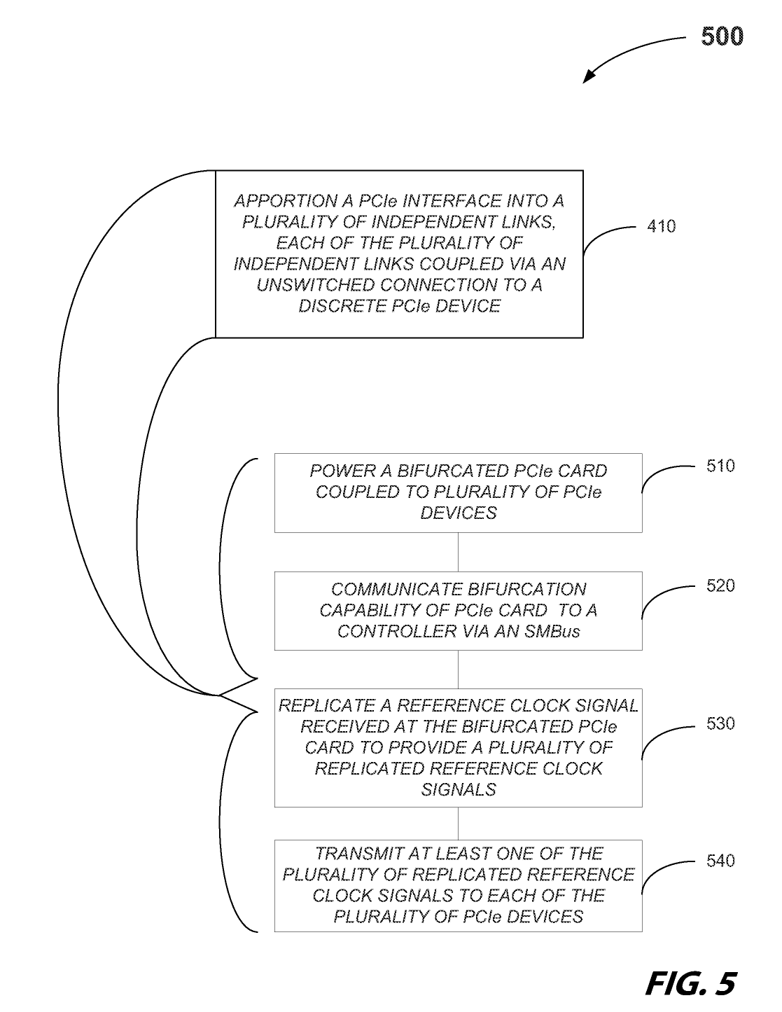

FIG. 5 is a flow diagram depicting another illustrative port bifurcation method 500, according to one or more embodiments. FIG. 5 depicts one example method for apportioning the PCIe interface 110 into a plurality of independent links each coupled to a discrete PCIe device 120a-d, as described with reference to FIG. 4 at 410.

The method 500 can include powering the PCIe port bifurcation card 100 coupled to the plurality of PCIe devices 120 at 510. The method 500 can further include communicating the port bifurcation capability of the PCIe card 100 from the ROM 140 to the controller 240 via the SMBus 250 at 520. The method 500 can also include replicating a reference clock signal 170 received by the PCIe card 100 using the clocking signal replicator 160 at 530. The method 500 can also include transmitting the plurality of replicated reference clock signals 180a-d to each of the plurality of PCIe devices 120a-d at 540.

Powering the PCIe port bifurcation card 100 coupled to the plurality of PCIe devices 120 at 510 can include providing power to the card 100 using any available means, such transfer may include direct or indirect transfer of power to the card 100. In some embodiments, the system to which the card 100 is coupled can provide at least a portion of the power for the card, for example via the PCIe slot 210. Power can be supplied to the card 100 via the PCIe slot 210 upon initial power-up of the system 200. Power can be supplied to the card 100 via the PCIe slot 210 when the system 200 is powered and the card is inserted into the PCIe slot 210, i.e., hot-plugging the PCIe card 100 into the PCIe slot 210.

Communicating the bifurcation data from the ROM 140 to the controller 240 via the SMBus 250 at 520 can include transmitting digital data stored on the card to an external controller. The transmission of the bifurcation data at 520 can be used to initialize the controller 240, thereby permitting the use of a single controller 240 to communicate with the plurality of PCIe devices 120a-d.

In some embodiments, the port bifurcation capability of the card 100 can be fixed by the card supplier or manufacturer. In such a case, the digital data defining the bifurcated nature of the card 100 can be permanently stored within the ROM 140 and communicated to the controller 240 upon the initial application of power to the card.

In other embodiments, the port bifurcated nature of the card 100 can be variably set by the system user. In such a case, the digital data defining the bifurcated nature of the card 100 can be set by the user via one or more hardware or software inputs. Once set, the digital data defining the bifurcated nature of the card can be stored at least partially within the ROM 140 and communicated to the controller 240 upon the initial application of power to the card.

Replicating a reference clock signal 170 received by the PCIe card 100 using the clocking signal replicator 160 at 530 can include, in some embodiments, replicating the reference clock signal 170 via a zero delay clocking signal replicator 160. In at least some embodiments, the clocking signal replicator can include, but is not limited to a Phase Lock Loop (“PLL”) based signal replicator generating a plurality of replicated reference clock signals 180a-d, each offering a zero delay. Generation of a replicated reference dock signal 180 can facilitate the synchronization of the plurality of PCIe devices 120a-d coupled to the card 100. Synchronization of the plurality of PCIe devices 120a-d can permit the use of a single controller 240 for the plurality of PCIe devices.

Though depicted sequential for convenience, discussion and readability, at least some of the actions, steps, or sequences depicted in FIGS. 4 and 5 can be performed in a different order and/or in parallel. Additionally, one or more specific embodiments may perform only a limited number of the actions, steps, or sequences depicted in FIGS. 4 and 5.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

While the foregoing is directed to embodiments of the present invention, other and further embodiments of the invention may be devised without departing from the basic scope thereof, and the scope thereof is determined by the claims that follow.

We claim the following:

1. A Peripheral Component Interconnect Express (PCIe) card comprising:
a PCIe interface;
a plurality of PCIe devices, each device independently coupled to the PCIe interface via an unswitched connection;
a read only memory (ROM) coupled to the PCIe interface, the ROM including bifurcation data; and
a clocking signal replicator coupled to the interface to:
replicate a reference dock signal received via the interface; and
provide the replicated reference dock signal to each of the plurality of PCIe devices.

2. The device of claim 1, the PCIe interface couplable to a PCIe slot within a computing device.

3. The device of claim 1, the PCIe interface bifurcated to provide a plurality of independent links;
each of the plurality of independent links associated with one of the plurality of PCIe devices; and
each of the plurality of independent links including an equal number of lanes.

4. The device of claim 1, the PCIe interface bifurcated to provide a plurality of independent links;
each of the plurality of independent links associated with one of the plurality of PCIe devices; and
at least two of the plurality of independent links including an unequal number of lanes.

5. The device of claim 1, the reference clock signal comprising a system clock signal provided by a controller via the PCIe interface.

6. The device of claim 1, the ROM coupled to a System Management bus (“SMBus”) coupled to a controller via the PCIe interface.

7. The device of claim 6, wherein upon powering the PCIe card the ROM transmits the PCIe card bifurcation data via the SMBus.

8. The device of claim 1, the clocking signal replicator comprising a phase lock loop.

9. A method for bifurcating a PCIe interface to support a plurality of PCIe devices, comprising:
apportioning the PCIe interface into a plurality of independent links, each of the plurality of independent links coupled via an unswitched connection to a PCIe device; and
programming a controller to communicate with each of the plurality of PCIe devices via at least one of the plurality of links.

10. The method of claim 9, wherein apportioning a PCIe interface into a plurality of independent links comprises:
powering a bifurcated PCIe card coupled to the plurality of PCIe devices;
communicating bifurcation data from a read-only memory (“ROM”) on the PCIe card to the controller;
replicating a reference clock signal received via the PCIe interface; and
transmitting the replicated docking signal to each of the plurality of PCIe devices.

11. The method of claim 10, the bifurcation data communicated from the ROM to the controller via a System Management bus (“SMBus”).

12. The method of claim 10, wherein the reference dock signal comprises a reference dock signal provided by a computing device coupled to the PCIe card.

13. The method of claim 10, wherein replicating the reference dock signal comprises:
providing the reference dock signal to a phase lock loop on the PCIe card; and
replicating the reference dock signal via the phase lock loop to provide a plurality of synchronized replicated reference clock signals.

14. The method of claim 9, wherein each of the plurality of independent inks contain an equal number of lanes, providing a plurality of independent, equal width, links.

15. The method of claim 9, wherein at least two of the plurality of independent links include an unequal number of lanes, providing a plurality of independent, unequal width, links.

16. A Peripheral Component Interconnect Express (PCIe) port bifurcation system, comprising:
a computing device including:
at least one PCIe slot;
a controller; and
a System Management bus (“SMBus”); and
a PCIe card coupled to the PCIe slot, the PCIe card including:
a plurality of PCIe devices, each device independently coupled via an unswitched connection to a PCIe interface, the PCIe interface bifurcated into a plurality of independent links;
a read only memory (ROM) to communicate bifurcation data from the ROM to the controller via the SMBus upon powering the PCIe card; and
a phase lock loop coupled to the interface to:
replicate a reference clock signal to provide a plurality of replicated reference clock signals; and
provide at least one of the plurality of replicated reference clock signals to each of the plurality of PCIe devices.

17. The system of claim 16, the controller to:
assign at least one of the plurality of independent links to each of the plurality of PCIe devices.

18. The system of claim 17, each of the plurality of independent links including an equal number of lanes, providing a plurality of independent, equal width links.

19. The system of claim 17, at least two of the plurality of independent links including an unequal number of lanes, providing a plurality of independent, unequal width links.

20. The system of claim 16, the controller comprising:
a PCIe controller;
a SMBus controller; and
a clock controller.
